(19) United States
(12) Patent Application Publication
(10) Pub. No.: US 2012/0267283 A1
(43) Pub. Date: Oct. 25, 2012

(54) Method of forming a tackle storage assembly and structure therefor

(76) Inventor: Jefferson Waring Hall, Chandler, AZ (US)

(21) Appl. No.: 13/066,782

(22) Filed: Apr. 25, 2011

(51) Int. Cl. B65D 1/34; B23P 19/00

(52) U.S. Cl. 206/557; 29/428

(57) ABSTRACT

In one embodiment, a tackle storage assembly may be formed with pivoting trays and surrounding a member to which a seat can be attached.

### BACKGROUND OF THE INVENTION

The present invention relates, in general, to tackle storage, and more particularly, to a tackle storage assembly formed with trays that rotate about a hinge facilitating user access. Moreover, the present invention features placement surrounding a post or member. More particularly still, additional features of the present invention include stacking more than one storage assembly atop one another and latching features for keeping the assemblies coupled around the member.

Fisherman and boaters alike have had a need for storage of tackle and other gear in a manner that provides for expandability and easy accessibility, yet has kept any storage assembly out of the way for other activities such as freely moving around a boating platform. Various tackle storage assemblies have existed in the prior art which have made attempts to serve these needs. Typically, tackle storage addressing accessibility has consisted of trays within an enclosure that are accessed through a rotating action of stacked tiers about central axis in a cylindrical enclosure, a pivoting action of tiers from within a box, or through sliding stacked trays from within a box. Some prior configurations consisted of exterior enclosures that have been attached to the underside of a seat thereby having removed the necessity to store them in locations that interfere with the tackle user's mobility.

Some configurations that attempt to address expandability and the accessibility, of tackle are tackle boxes having vertically stackable trays that are independently rotatable about a common central axis. Such attempts may require a bottom tray with a receiver for a shaft, a tray with a shaft receiving sleeve and a central shaft. However, designs such as these could suffer from some shortcomings. These configurations require the cumbersome and excessive, time consuming assembly of many intricate parts leading to unnecessary expense and uncompetitive cost. When the assemblies are completed, the resulting containers have to be stored away from the user, resulting in lack of ease of access, or placed locally for access by the user. When placed locally, for example on the fishing or boating platform, they can interfere with the user's mobility. An additional shortcoming of these configurations could be that, because of the need to access the stored equipment through openings in the trays, the stackable trays do not have storage volume throughout the complete circumference around the central axis. Yet another shortcoming of these configurations could be the lack of a tray separation or covering means to prevent moisture ingress and the resulting damage to stored tackle as well as prevent smaller items such as hooks from becoming wedged between trays, preventing them from being freely rotated.

There are also designs that attempt to address the previously described problems with user mobility. Some designs disclose a portable tackle box that can be attached with brackets to the underside of a standard pedestal fishing seat. Designs such as these can suffer from shortcomings associated with expense and cost as well as the flexibility to adapt to the different seat configurations that are common in modern recreational and professional fishing. Many rugged and relatively expensive parts are required to attach these designs to the underside of a seat including the brackets to hold these boxes and the mounting hardware to attach them to the seat in a semi-permanent manner. It is also very typical to find at least two different seat configurations in a single boating or fishing application, each of which being used by different people who have different tackle needs. One of the typical seat configurations is referred to as a professional, or “pro”, seat. This seat is typically much smaller than another and has an irregular shape designed for user comfort while the user is standing, yet leaning against the seat. As such, these designs can be practically incompatible with these seat configurations.

Accordingly, it is desirable to have a tackle storage system that allows for user mobility, is compatible with standard pedestal and seat configurations, is flexible and expandable, and is economical.

### BRIEF DESCRIPTION OF THE DRAWINGS

FIG. 1 is a top plan view of a tackle storage assembly in the latched assembly position in accordance with an embodiment of the present invention;

FIG. 2 is an exploded side plan view of the hinged assembly side of a tackle storage assembly in accordance with an embodiment of the present invention;

FIG. 3 is a side plan view of the latched assembly side of a tackle storage assembly in accordance with an embodiment of the present invention;

FIG. 4 is a side plan view of the hinged cover side of one section of a tackle storage assembly in accordance with an embodiment of the present invention;

FIG. 5 is a side plan view of the latched cover side of one section of a tackle storage assembly in accordance with an embodiment of the present invention;

FIG. 6 is a perspective view of a circular plate section adapted for use with a tackle storage assembly in accordance with an embodiment of the present invention;

FIG. 7A is a side plan view of a stacked configuration of a tackle storage assembly in accordance with an embodiment of the present invention;

FIG. 7B is a side plan view of a stacked configuration of a tackle storage assembly showing the hinged assembly detail in accordance with an embodiment of the present invention;

FIG. 8 is a top plan view of a tackle storage assembly in the user access assembly position in accordance with an embodiment of the present invention;

FIG. 9A illustrates a perspective view of a self-contained tackle storage assembly which is an alternate embodiment of the present invention; and

FIG. 9B is a perspective view of a tackle storage frame used with the tackle storage assembly shown in FIG. 9A in accordance with an embodiment of the present invention.

For simplicity and clarity of illustration, elements in the figures are not necessarily to scale, are only schematic and non-limiting, and the same reference numbers in different figures denote the same elements, unless stated otherwise. Additionally, descriptions and details of well-known steps and elements are omitted for simplicity of the description. It will be appreciated by those skilled in the art that words such as “when” and “then” may be used herein and are not exact terms that mean an action takes place instantly upon an initiating action but that there may be some reasonable delay between initial action and resulting action. Additionally, the term “include” is not an exact term representing specific spatial relationships between items but generally mean to have as a component. Also, terms such as “attached” and “connected” are not meant to be limited only to direct coupling, but include coupling through intervening elements as well. The use of words such as “roughly”, “approximately” or “substantially” means that a value of an element has a parameter that is expected to be close to a stated value or position. However, it is well known in the art that there are always minor variances that prevent the values or positions from being exactly as stated. It is well established in the art that variances of up to at least ten per cent (10%) are reasonable variances from the ideal goal of exactly as described.

### DETAILED DESCRIPTION OF THE DRAWINGS

The present description includes, among other features, a storage assembly having a plurality of trays coupled together with a hinge and shaped to fit around an object such as a post. It should be understood that there are many other ways of practicing that which is described herein, and that the embodiments described herein are exemplary and not limiting.

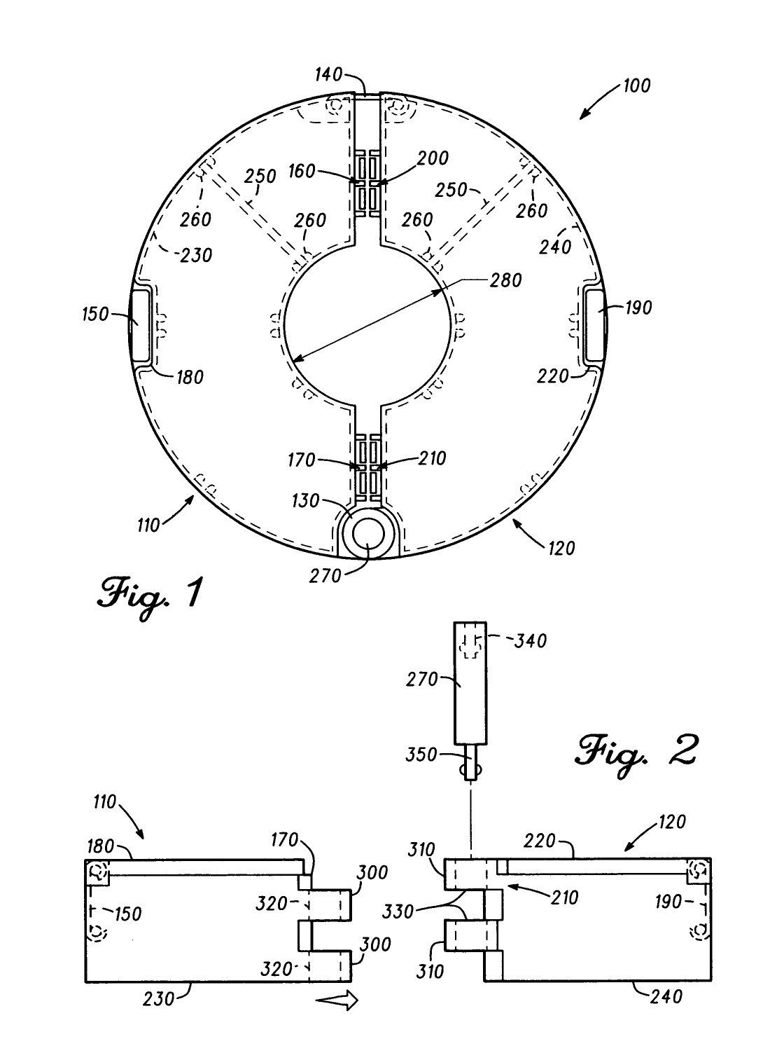

FIG. 1 depicts a tackle storage assembly 100 having a left semi-circular section 110 and a right semi-circular section 120 that are coupled together with hinge assembly structure 130 and latch assembly structure 140. The hinge assembly structure 130 contains hinge pin 270. Left semi-circular section 110 includes latch 150, hinges 160 and 170, and cover 180. Right semi-circular section 120 includes latch 190, hinges 200 and 210, and cover 220. Left semi-circular section 110 also includes left tray 230 and right semi-circular section 120 includes right tray 240. Left semi-circular section 110 and right semi-circular section 120 can include removable dividers 250.

Removable dividers 250 can be held in place by tray extensions 260.

The components of tackle storage assembly 100 may be constructed from one or more of many common materials such as aluminum or plastic. The tackle storage assembly 100 components can be made from plastic through an injection molding process commonly known in the art.

The components of tackle storage assembly 100 can be assembled easily due to the composition and design of the individual components. Covers 180 and 220 can be connected to trays 230 and 240 respectively, by hinges 160 and 170 and by hinges 200 and 210 respectively. The design of the hinges 160, 170, 200 and 210 to allow these connections is commonly known to those skilled in the art.

Latch 150 can be coupled to cover 180 due to similar material composition and component design. When cover 180 is closed, the latch 150 can be rotated into a position causing it to latch to left tray 230. In much the same manner, latch 190 is coupled to cover 220. When cover 220 is closed, the latch 190 can be rotated into a position causing it to latch to right tray 240. In alternate embodiments, the latches 150 and 190 can be coupled to left tray 230 and right tray 240 respectively and rotated into a position such that they latch to covers 180 and 220. Users may gain access to the internal storage space of either tray 230 or 240 through rotation of either latch 150 or 190 respectively, followed by a lifting of either cover 180 or 220 respectively. Lifting or closing covers 180 or 220 causes the covers 180 or 220 to rotate about the hinges 160 and 170 or 200 and 210 respectively.

The tackle storage assembly 100 dimensions can be designed according to the size of the member around which it will be positioned and the size of tackle to be stored therein. The inner diameter 280 of the tackle storage assembly 100 as measured across the inner opening may be greater than but no less than approximately one and one-half inches (1.5″) as diameter of the member around which it will be placed can be approximately one and one-half inches (1.5″).

The outer diameter of the tackle storage assembly 100 can be designed to suit the type of tackle intended to be stored therein. However, it can be from eight (8) to twelve (12) inches in diameter to accommodate fishing tackle.

The depth of the left tray 230 and right tray 240 can vary widely based on application. The depths typically will range from one (1) inch to three (3) or more inches. It is anticipated that tackle storage assemblies of varying depths can be mixed and stacked as described herein. The sizes of the removable dividers 250 can be based on the dimensions of the left and right trays 230 and 240 and made to fit snugly within the tray extensions 260 which may be extended into the cavity by one-eighth (⅛) inch or more and can be the same depth as the trays 230 and 240. Tray extensions 260 may be provided as shown or in alternative positions depending on the nature of the equipment to be stored.

Latch assembly structure 140 can be coupled easily to right tray 240 of right semi-circular section 120 due to similar material composition and component design. When left semi-circular section 110 or right semi-circular section 120 are rotated about hinge assembly structure 130 so they are placed adjacent to one another as shown in FIG. 1, the latch assembly structure 140 can be rotated into a position causing it to latch to tray 230. The hinges 160 and 200, and 170 and 210 respectively, can be dimensioned such that they are in contact when the latch assembly structure is in the latched position causing the tackle storage assembly 100 to be mechanically stable. As such, the hinges 160, 170, 200 and 210 still allow covers 180 and 220 respectively to rotate.

Hinge assembly structure 130 may be constructed with elements of both left semi-circular section 110 and right semi-circular section 120 and will be described in greater detail with reference to FIG. 2. The hinge assembly structure may also be constructed to accept hinge pin 270 such that either semi-circular section can be rotated with respect to one-another in a smooth motion about the hinge axis. The hinge pin 270 may be constructed from similarly injection molded plastic to allow smooth rotation and may be approximately one half (½) inch in diameter. The diameter of the hinge pin 270 will be designed in order to provide strength depending upon the final size of the left and right semi-circular sections 110 and 120 to account for the weight of items stored.

FIG. 2 is an exploded side plan view of the hinged assembly side of the tackle storage assembly 100 showing how the left semi-circular section 110 and right semi-circular section 120 may be assembled together using hinge pin 270. Left tray 230 may have one or more left hinge extensions 300 and right tray 240 may have one or more right hinge extensions 310 that mate together when assembled. The left hinge extensions 300 may have cylindrical cavities 320 and the right hinge extensions 310 may have cylindrical cavities 330 that align on a common axis when the two sections are mated which allow for the insertion of hinge pin 270 as indicated by the dotted line along the common axis as shown, thereby creating hinge assembly structure 130 of FIG. 1.

Hinge pin 270 may have a form allowing for the series connection of a plurality of the pins by way of narrow cylindrical cutout 340 and narrow cylindrical post 350. The narrow cylindrical post 350 may be slightly less up to approximately the same diameter as the narrow cylindrical cutout 340. Thus, when one hinge pin 270 is coupled to another, the post 350 and cutout 340 mate forming a sound mechanical connection. Note that the height of the hinge pin 270 may be greater than the heights of the semi-circular sections 110 and 120 such that when the post 350 of a first hinge pin 270 is inserted into a cutout 340 of a second hinge pin 270, the effective additional height of the first may be the same as the height of the semi-circular sections.

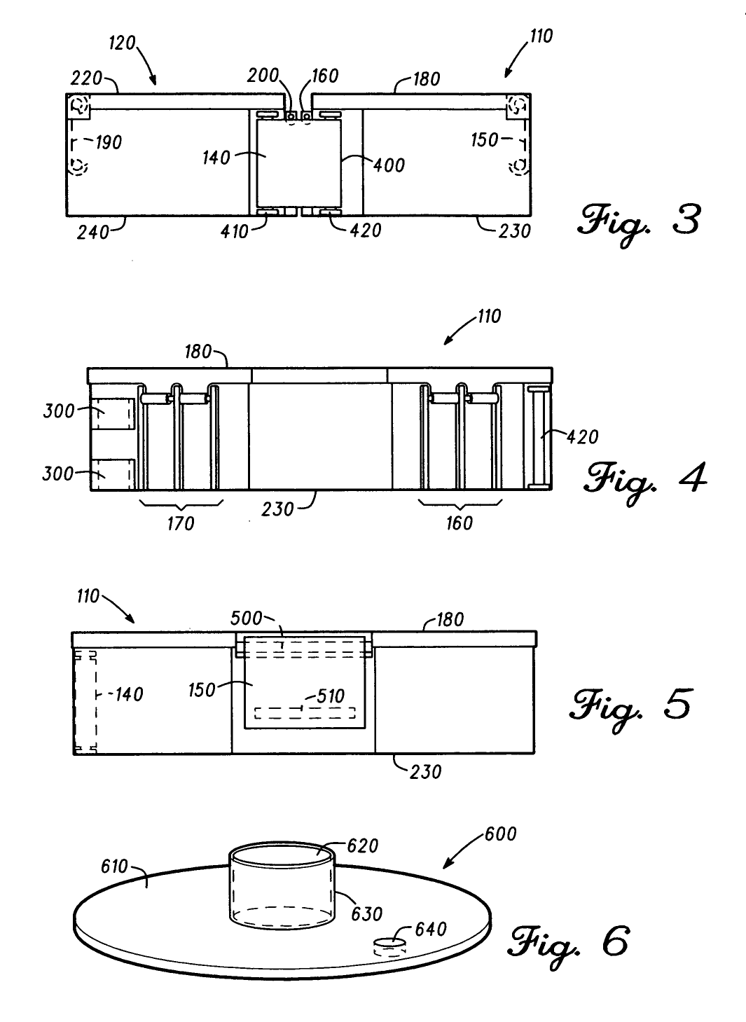

A side plan view of the latched assembly side of the tackle storage assembly 100 is shown in FIG. 3. Latch assembly structure 140 is shown in this plan view. It should be noted that the latch is opened on the right side with reference to the preferred embodiment shown in FIG. 3, as indicated by the laterally extended cavity 400 in the right tray 230 to allow the user to grasp and open or close the latch structure 140. The latch assembly structure 140 may rotate about pin structure 410 when opened and closed and may snap around latch clip 420 when closed. This latching action caused by pressure exerted by a user can be designed to be strong enough to maintain the latching action under normal use until unlatched by further user action. These structures are well known to those skilled in the art.

A depiction of a side plan view of the hinged cover side of the left semi-circular section 110 of the tackle storage assembly 100 is drawn in FIG. 4. This depiction, in combination with the other figures of this description, shows features of hinges 160 and 170 that may allow for free movement of cover 180 about the hinges.

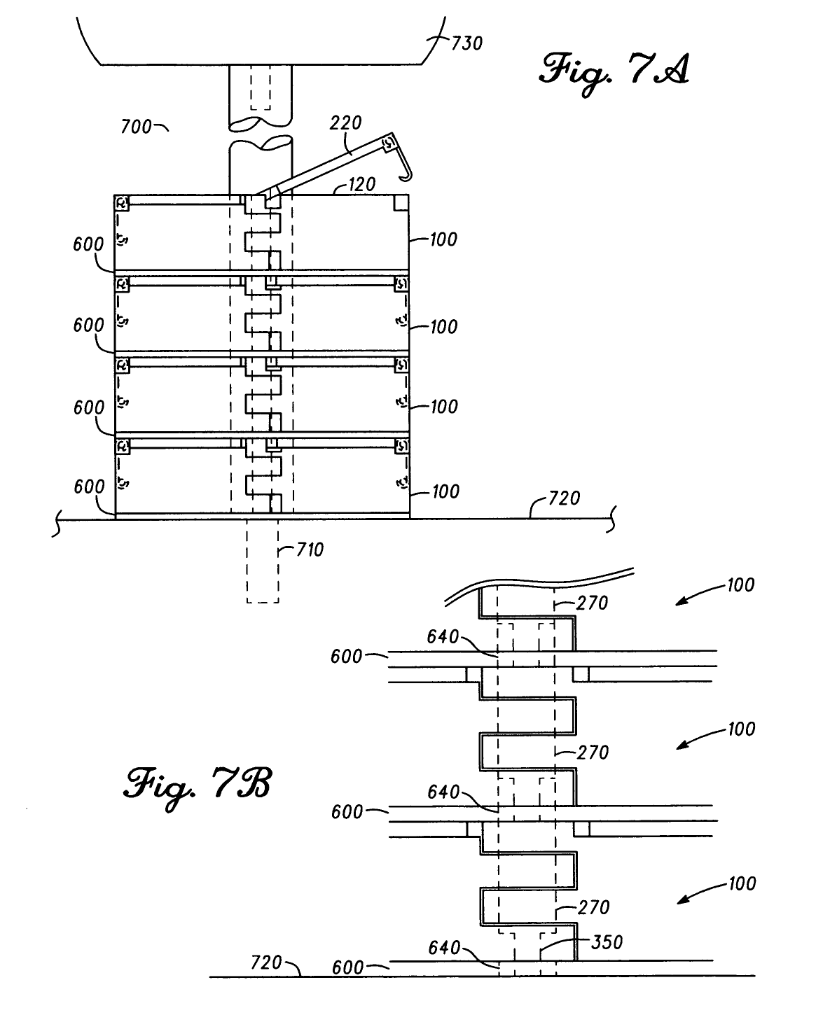

A depiction of a side plan view of the latched cover side of the left semi-circular section 110 of the tackle storage assembly 100 is drawn in FIG. 5. In this figure, the latch 150 may rotate freely around latch hinge 500 when opened and closed and may snap around latch clip 510 when closed. This latching action caused by pressure exerted by a user can be designed to be strong enough to maintain the latching action under normal use until unlatched by further user action.

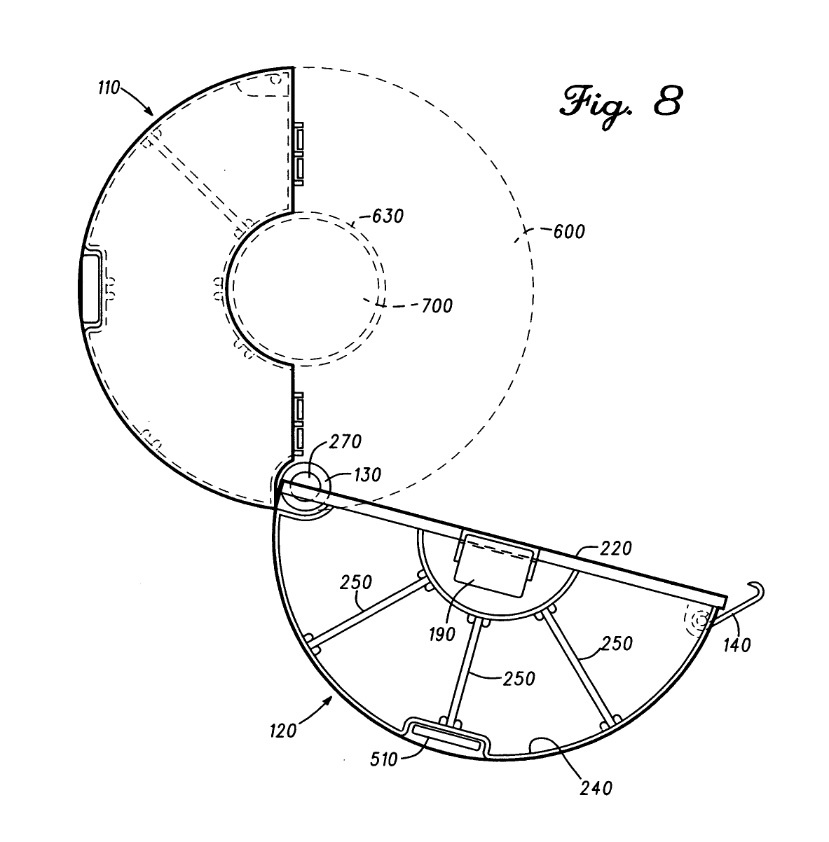

FIG. 6 shows a perspective view of a circular plate section 600 adapted for use with stacked tackle storage assemblies 100 and may be used about a member as described previously. Circular plate section 600 may be constructed of similar materials as disclosed previously for the tackle storage assembly 100. Circular plate section 600 may consist of a thin, uniform circular plate 610 with a circular center cutout 620 and a circular perimeter cutout 640. A hollow cylinder 630 may be attached to circular plate 610, with a single process and a single contiguous injection molded form, in a similar manner as other parts of the tackle storage assembly 100. The circular plate 610 and hollow cylinder 630 may be of sufficient thickness, about one-sixteenth ( 1/16) to one-eighth (⅛) of an inch, to maintain long term structural integrity over the normal course of use. Additionally, the hollow cylinder 630 may have an inner diameter that will typically be only slightly larger than, and to within manufacturing tolerances of the member, such that when placed, it may fit around the member without being excessively loose. For example, the hollow cylinder 630 inner diameter may be about one-eighth (⅛) of an inch greater than the member around which it is placed. The hollow cylinder 630 may be positioned within the inner diameter 280 in FIG. 1 of tackle storage assembly 100 when assembled together as will be shown in FIG. 7A and FIG. 7B. Therefore, the inner diameter 280 may be only slightly larger than, and to within manufacturing tolerances of the outer diameter of the hollow cylinder 630. Additionally, the height of the hollow cylinder 630 may be no greater than the height of the tackle storage assembly 100 and up to approximately one quarter inch (¼″) less than the height of tackle storage assembly 100. Circular perimeter cutout 640 may be intended to receive a hinge pin when in the stacked configuration shown next in FIG. 7A and therefore only have a diameter slightly greater than the diameter of the hinge pin 270. Variations on these dimensions are meant to be fully anticipated within the scope of this description.

A side plan view of a stacked configuration of tackle storage assemblies 100, as applied in a typical user environment, is disclosed in FIG. 7A. For purposes of illustration, a stack of four tackle storages assemblies 100 and circular plate sections 600 are shown as applied in a user environment surrounding a seat post member 700. An extension 710 of seat post member 700 can be fit into a mating connection in the surface of the user platform 720. Additionally, a seat 730, may be fit atop the seat post member 700, although this is not required. The stacked assembly in the user environment is not limited to any predefined number of tackle storage assemblies 100 nor is it limited to any predefined height of seat post member 700. The flexibility granted to the user in choosing the preferable number of assemblies is one advantage disclosed herein.

A circular plate section 600 may be placed over and along the central axis of seat post member 700, followed by similar placement of a tackle storage assembly 100. As such, the tackle storage assembly 100 may fit on top of the circular plate section 600, which in turn fits around the seat post member 700 and rests on user platform 720. This process may then be repeated until the user has placed the number of circular plate sections 600 and tackle storage assemblies 100 he or she desires. Placement of each section of the stack may include assembly of one hinge pin 270 to another as described with reference to FIG. 1 and FIG. 2. When assembled as such, the combination of circular plate section 600 with tackle storage assembly 100 can give structural integrity to the stack such that when a semi-circular section 110 or 120 from FIG. 1 is rotated outward into a user access position, the tackle storage assemblies above the accessed assembly are fully supported. However, use of the circular plates is not mandatory as the stack is structurally sound without the use of the circular plate sections 600.

The order of assembly of the circular plates 600 and tackle storage assemblies 100 can be reversed as well which has the advantage of additional user flexibility. Assembled in this manner, the user may place tackle storage assembly 100 over and around seat post member 700 first, followed by circular plate section 600. This process may be continued until the desired number of tackle storage assemblies 100 are stacked. Placement of the last circular plate section 600 which, in this case, may rest atop the tackle storage assembly last placed, is not necessary.

It is in these stacked assemblies that one can find the structural advantage provided by the hollow cylinders 630 of circular plates sections 600. The connection of the hollow cylinders 630 around the seat post member 700, and inside of tackle storage assembly 100, and to circular plate 610 can result in mechanical leverage in support of the tackle storage assemblies 100 resting higher in the stack.

It should be noted that the cover 220 of right semi-circular section 120 of the tackle storage assembly 100 on the top of the stack is shown in a partially open position. In order to gain full access, the user may rotate the right semicircular section 120 away from the seat post member 700. It is in these positions that the user can gain access to items stored in the topmost tackle storage assembly as described with reference to FIG. 1. It should also be noted that seat post member 700 may be constructed of a plurality of sub-members. It may also be designed to have various cross sections. These different design configurations including multiple sub-members and cross-sections are within the scope of the description and tackle storage assembly 100 can be designed to accommodate these variations.

Shown in FIG. 7B is a side plan view of a stacked configuration of a tackle storage assembly 100 with hinged assembly detail. The stacked configuration shown may have a circular plate section 600 resting on user platform 720, followed by a tackle storage assembly 100, followed by further combinations of circular plate section 600 and tackle storage assembly 100. Hinge pin 270 may be inserted into each successive combination of circular plate 600 and tackle storage assembly 100. The first hinge pin 270 may be inserted until the post 350 reaches the user platform 720. Additional pins may be inserted into the previous pin along with each circular plate section 600 and tackle storage assembly 100 combination until the posts 350 reach the extent of the cylindrical cutouts 340 as shown in FIG. 2.

Hinge pins 270 may be designed such that, when assembled into the stacked storage assembly, they may reach not only into the cylindrical cutouts 340 of the hinge pin 270 immediately beneath in the storage assembly stack, but also through the circular perimeter cutout 640 of each circular plate section 600. This may help to provide additional structural stability and prevent unnecessary rotation of the circular plates when users access the tackle storage assemblies 100 through rotation on the hinge.

It should be noted that the circular plate sections 600 can be constructed with a smaller radius which would eliminate the requirement for circular perimeter cutouts 640 as the hinge pins would then bypass the circular plates sections 600 altogether when the stacked storage assembly is constructed.

Additionally, the user can remove a portion or all of the post 350 of the first hinge pin 270 in the lowest portion of the stack. In that manner, the upper most hinge pin 270 in the stack may not protrude completely or at all from the top when assembled.

A top plan view of a tackle storage assembly 100 in the user access assembly position is illustrated in FIG. 8. This figure shows the right semicircular section 120 rotated outward and away from left semicircular section 110 about the hinge pin 270 of the hinge assembly structure 130. This may be enabled through the opening of latch assembly structure 140 outward from its coupling to left semicircular section 110. Rotation of the right semicircular section 120 in this manner may allow user access as the section 120 may no longer be obstructed by the tray immediately above in the stacked configuration of the tackle storage assembly as shown in FIG. 7A. The latch 190 may then be decoupled from its latch clip 510 and cover 220 rotated up and away from tray 240 to facilitate access to any tackle stored within. It should be noted that the cover 220 and tray 240 in the immediate vicinity of the hinge structure 130 may be designed such that the rotation upward and away from tray 240 does not either interfere with hinge structure 130, hinge pin 270 or the tray immediately above in the stacked configuration shown in FIG. 7A. It should be noted that it is fully within the scope to position hinge structure 130 at a greater radius from the seat post member 700 or beyond the outer circumference of the left semi-circular section 110 and right semi-circular section 120. This may facilitate a less intricate design of components and a wider rotational arc of the sections being accessed around the hinge structure 130, as well as a greater upward rotation of cover 220 away from tray 240. The relative positions of the circular plate section 600, hollow cylinder 630 and seat post member 700 in this example application are shown for clarity.

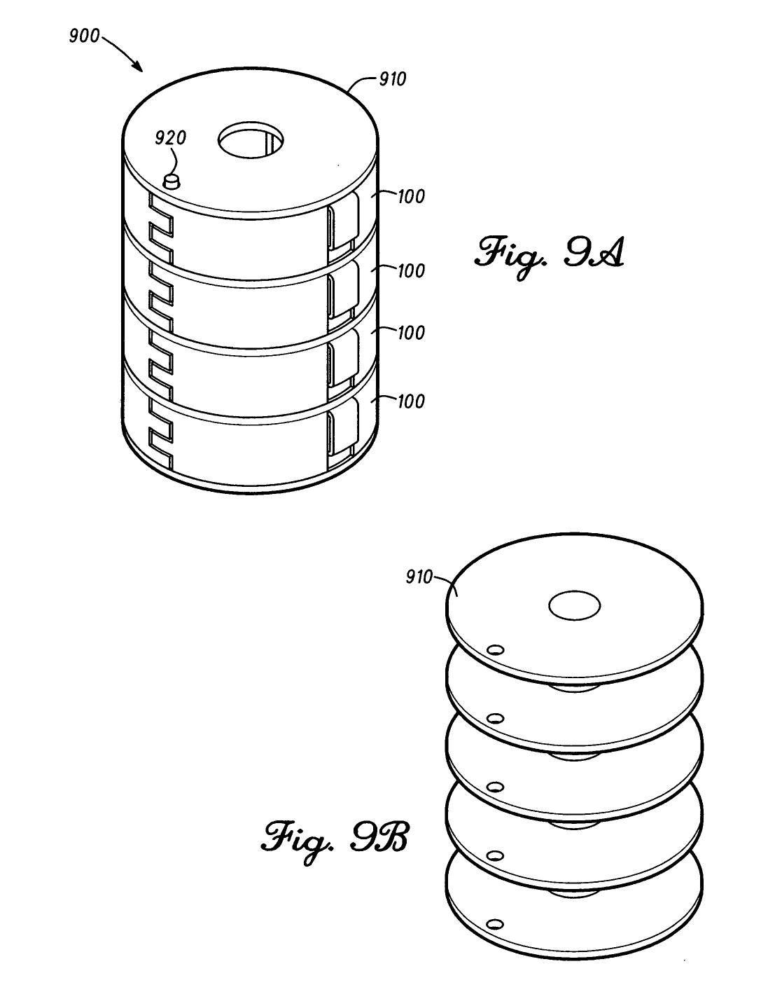

An alternate embodiment showing a perspective view of a self-contained tackle storage assembly 900 is drawn in FIG. 9A. This assembly may consist of a frame 910 combined with the previously described tackle storage assemblies 100. The hinge pin 920 in this self-contained tackle storage assembly can be constructed as described previously with multiple hinge pins 270, or with a single long piece as shown. This may have the benefit of being a single unit when fully assembled, but may lack the ability to completely customize the number of levels of the assembly. It is anticipated that users of the assemblies will choose their preferred embodiment.

FIG. 9B illustrates a perspective view of a tackle storage frame 910 that may be used with the tackle storage assembly shown in FIG. 9A.

In view of all of the above, it is evident that a novel assembly, method of forming the assembly, and method of using the assembly are disclosed. Included, among other features, is forming an assembly with at least two sections coupled together with a hinge and shaped to fit around a central member.

While the subject matter of the invention is described with specific preferred embodiments, the foregoing drawings and descriptions thereof depict only typical and exemplary embodiments of the subject matter and are not therefore to be considered to be limiting of its scope. It is evident that many alternatives and variations will be apparent to those skilled in the art. For example, the subject matter has been described with respect to an example of a method of using with respect to fishing tackle and fishing boats. However, the subject matter is directly applicable to any other items to be stored in a similar manner and with respect to any application.

As the claims hereinafter reflect, inventive aspects may lie in less than all features of a single foregoing disclosed embodiment. Thus, the hereinafter expressed claims are hereby expressly incorporated into this Detailed Description of the Drawings, with each claim standing on its own as a separate embodiment of an invention. Furthermore, while some embodiments described herein include some but not other features included on other embodiments, combinations of features of different embodiments are meant to be within the scope of the invention, and form different embodiments, as would be understood by those skilled in the art.

1. A storage assembly comprising:
a plurality of trays;
said plurality of trays coupled together with a first hinge; and
said plurality of trays shaped to fit around a member.

2. The storage assembly of claim 1 further comprising a latch for further coupling said plurality of trays together.

3. The storage assembly of claim 1 further comprising a cover for one of said plurality of trays.

4. The storage assembly of claim 3 wherein said cover is coupled to one of said plurality of trays with a second hinge.

5. The storage assembly of claim 1 wherein said first hinge comprises a hinge pin.

6. The storage assembly of claim 5 wherein said first hinge pin is formed to couple to an additional hinge pin.

7. The storage assembly of claim 1 further comprising:
an additional plurality of trays;
said additional plurality of trays coupled together with an additional hinge;
said additional plurality of trays shaped to fit around said member; and
said hinge coupled to said additional hinge.

8. The storage assembly of claim 5 further comprising:
an additional plurality of trays;
said additional plurality of trays coupled together with a said hinge pin; and
said additional plurality of trays shaped to fit around said member.

9. A method of forming a storage assembly comprising:
coupling a plurality of trays with a hinge; and
coupling said plurality of trays around a member.

10. The method of claim 9 wherein an additional plurality of trays are coupled together with an additional hinge; and
said additional plurality of trays is coupled around said member.

11. The method of claim 10 wherein said plurality of trays and said additional plurality of trays are further coupled with said hinge and said additional hinge.

12. The method of claim 9 wherein said plurality of trays are further coupled with a latch.

13. A method of using a storage assembly comprising:
configuring a plurality of trays for coupling about a hinge around a member; and
forming one of said plurality of trays to rotate about said hinge.

14. The method of claim 13 wherein said plurality of trays are further coupled with a latch.

15. A method of forming a storage assembly comprising:
coupling a plurality of trays with a hinge pin; and
coupling said plurality of trays around a member.

16. The method of claim 15 wherein an additional plurality of trays are coupled together with said hinge pin; and
said additional plurality of trays is coupled around said member.

17. The method of claim 15 wherein said plurality of trays are further coupled with a latch.

18. The method of claim 15 wherein said plurality of trays are further coupled around a frame.
